(19) United States
(12) Patent Application Publication
(10) Pub. No.: US 2018/0012476 A1
(43) Pub. Date: Jan. 11, 2018

(54) SYSTEM FOR DETECTING WHEN A MAILBOX RECEIVES MAIL

(71) Applicant: George Clayton Haynes, Knoxville, TN (US)

(72) Inventor: George Clayton Haynes, Knoxville, TN (US)

(21) Appl. No.: 15/202,931

(22) Filed: Jul. 6, 2016

(51) Int. Cl. G08B 21/18; A47G 29/122; A47G 29/12

(52) U.S. Cl. CPC G08B 21/18; A47G 29/1214; A47G 29/1225

(57) ABSTRACT

A system for detecting mail intake is provided. The system includes a mailbox having a housing and an opening leading into the housing. A motion detector is operable to detect motion in an area around the opening. A wireless transmitter is operable to transmit a signal when the motion is detected. A remote device includes at least a wireless receiver and an indicator. The wireless receiver is operable to receive the signal and activate the indicator to produce an indication the motion is detected. Therefore, a user is notified when mail is delivered to their mailbox.

### BACKGROUND OF THE INVENTION

The present invention relates to mail boxes and, more particularly, to a system for detecting when a mailbox receives mail.

A mailbox is a receptacle for receiving incoming mail at a private residence or business. Currently, there is no system that notifies a user he or she has received mail within their mailbox.

As can be seen, there is a need for a system for detecting when a mailbox receives mail.

### SUMMARY OF THE INVENTION

In one aspect of the present invention, a system for detecting mail intake comprises: a mailbox comprising a housing and an opening leading into the housing; a motion detector operable to detect motion in an area comprising the opening; a wireless transmitter operable to transmit a signal when the motion is detected; and a remote device comprising a wireless receiver and an indicator, wherein the wireless receiver is operable to receive the signal and activate the indicator to produce an indication the motion is detected.

These and other features, aspects and advantages of the present invention will become better understood with reference to the following drawings, description and claims.

### BRIEF DESCRIPTION OF THE DRAWINGS

FIG. 1 is a perspective view of an embodiment of the present invention shown in use;

FIG. 2 is a perspective view of an embodiment of the present invention;

FIG. 3 is an exploded view of an embodiment of the present invention;

FIG. 4 is a section view of an embodiment of the present invention taken along line 4-4 in FIG. 1;

FIG. 5 is a front view of an embodiment used with a wall mount mailbox; and

FIG. 6 is a section view of the present invention taken along line 6-6 in FIG. 5.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a mail detection device that lets a user know that someone has opened their mailbox. When the door of the mailbox is opened, a motion detector is activated and sends a signal to the receiver or security systems. An indicator notifies the user that the motion detector sensed a motion.

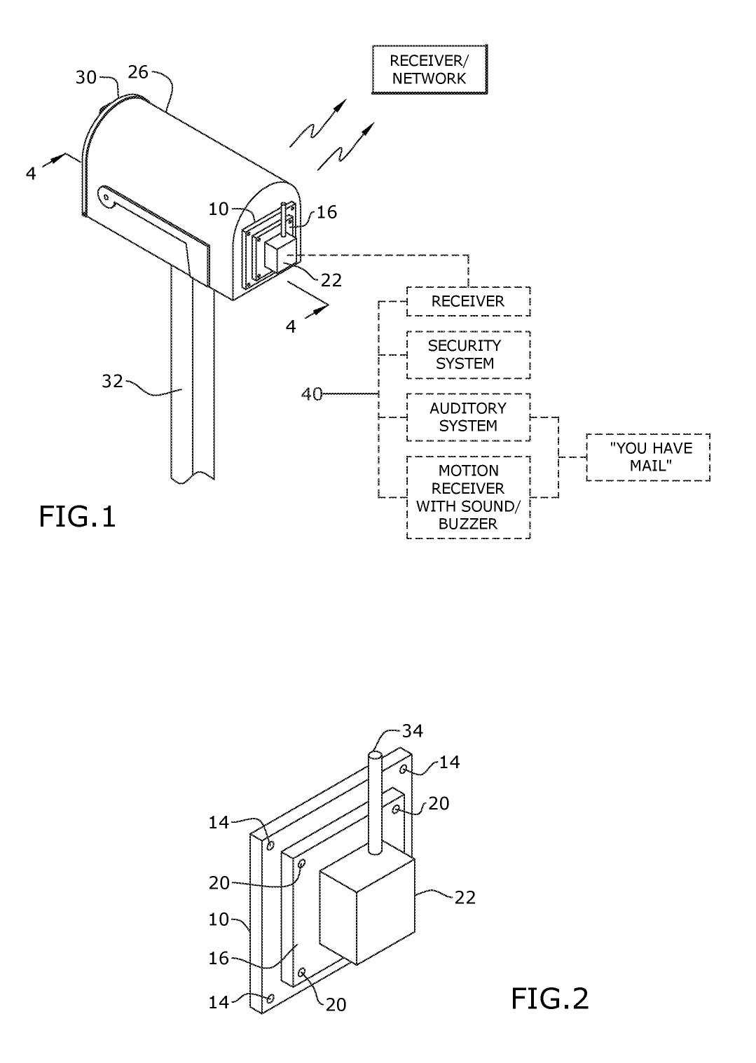

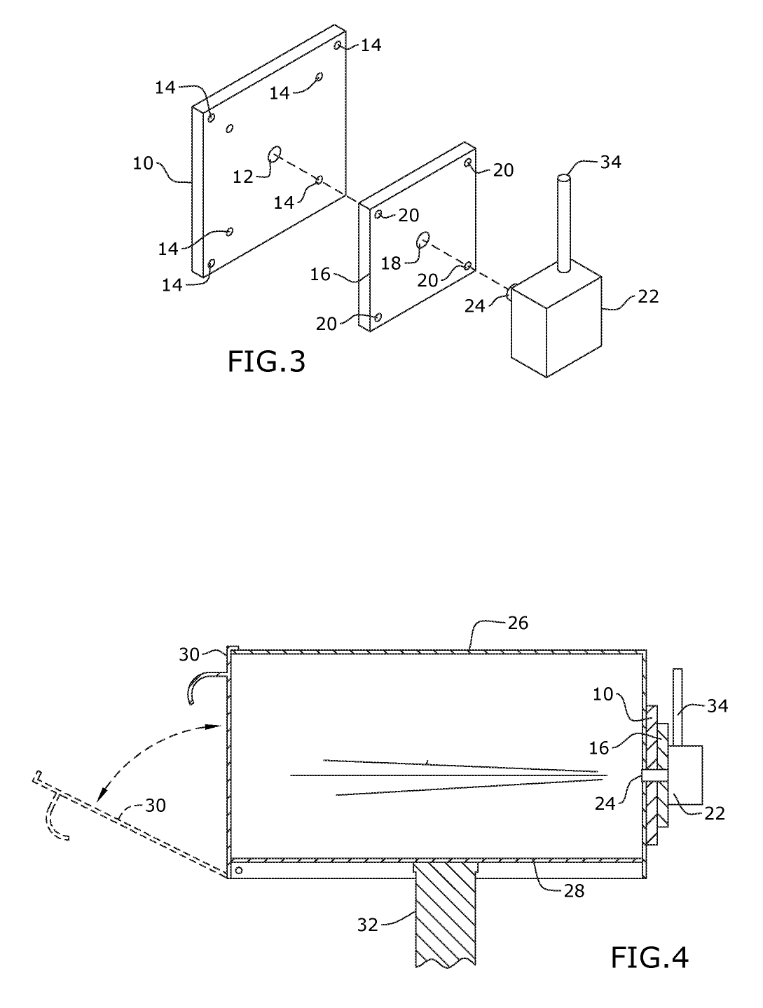

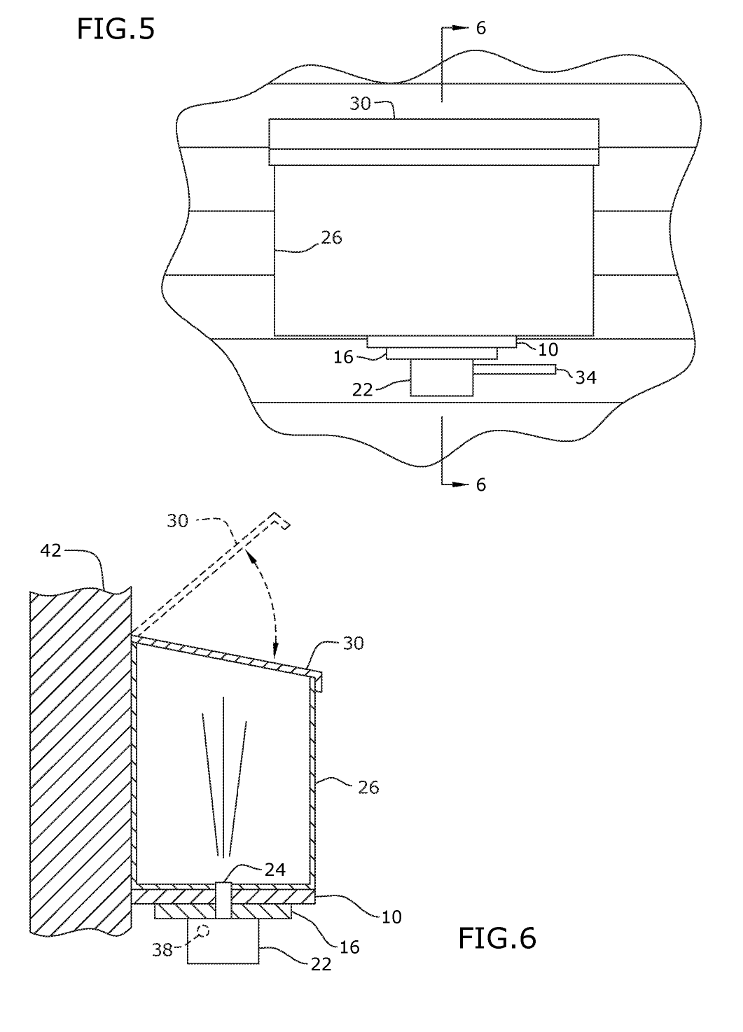

Referring to FIGS. 1 through 6, the present invention includes a system for detecting mail intake. The system includes a mailbox 26 having a housing 28 and an opening leading into the housing 28. A motion detector 22 is operable to detect motion in an area around the opening. A wireless transmitter 38 is operable to transmit a signal when the motion is detected. A remote device 40 includes at least a wireless receiver and an indicator. The wireless receiver is operable to receive the signal and activate the indicator to produce an indication the motion is detected. Therefore, a user is notified when mail is delivered to their mailbox 26

The remote device 40 of the present invention may include a computer, such as a smart device. In certain embodiments, the remote device 40 may be part of a security system. The indicator may be a speaker, a light, a user interface operable to produce a written text or a combination thereof. Therefore, when the motion is detected, a sound, a light, or a text message may be produced to notify the user.

The mailbox 26 of the present invention may be located on the street or may be attached directly to a building 42. When the mailbox 26 is on the street, the mailbox 26 may be supported by a post 32. In each embodiment, the mailbox 26 may include a door 30 hingedly attached to the housing 28 and operable to cover and reveal the opening. The motion detector 22 may detect the motion of the door 30 and thereby sends the signal when the door 30 is opened and closed.

In certain embodiments, the present invention may include a detector housing. The motion detector 22 and the transmitter 38 may be secured within or to the housing. An antenna 34 is operably connected to the transmitter 38 and extends from the detector housing.

The detector housing may be mounted to an outer surface the mail box 26. A detector eye 24 detects the motion through an aperture formed through the housing 28. The detector housing may be mounted to the outer surface by a mounting plate 10. The mounting plate 10 may include a plurality of inner openings 14 that aligns with outer openings 20 of a detector base 16. Bolts may run through the aligned openings 14, 20, thereby securing the detector base 16 to the mounting plate 10. The mounting plate 10 may include a plurality of outer openings 14. A plurality of bolts may run through the outer openings 14 and into the mailbox 26, thereby connecting the mounting plate 10 to the housing. A first beam opening 12 may be formed through the mounting plate 10 and a second beam opening 18 may be formed through the detector base 16. The detector eye 24 may run through the aligned openings 12, 18 and detect motion through the opening formed in the housing of the mailbox 26.

It should be understood, of course, that the foregoing relates to exemplary embodiments of the invention and that modifications may be made without departing from the spirit and scope of the invention as set forth in the following claims.

What is claimed is:

1. A system for detecting mail intake comprising:
a mailbox comprising a housing and an opening leading into the housing;
a motion detector operable to detect motion in an area comprising the opening;
a wireless transmitter operable to transmit a signal when the motion is detected; and
a remote device comprising a wireless receiver and an indicator, wherein
the wireless receiver is operable to receive the signal and activate the indicator to produce an indication the motion is detected.

2. The system of claim 1, wherein the indicator comprises at least one of a speaker, a light and a user interface operable to produce a written text.

3. The system of claim 1, wherein the mailbox further comprises a door hingedly attached to the housing and operable to cover and reveal the opening.

4. The system of claim 3, wherein the motion detector detects the motion of the door.

5. The system of claim 1, wherein the motion detector comprises a detector eye directed towards the opening.

6. The system of claim 5, wherein the motion detector is mounted to an outer surface the mail box, wherein the detector eye detects the motion through an aperture formed through the housing.

7. The system of claim 6, further comprising a mounting plate secured to the outer surface of the housing and a motion detector base secured to the mounting plate, wherein the detector eye runs through aligned apertures formed through the mounting plate and the motion detector base.

8. The system of claim 1, wherein the remote device is at least one of a smart device and a security system.

9. The system of claim 1, further comprising a detector housing comprising the motion detector and the transmitter.

10. The system of claim 9, further comprising an antenna operably connected to the transmitter and extending from the detector housing.
